(19) United States
(12) Patent Application Publication
(10) Pub. No.: US 2007/0072761 A1
(43) Pub. Date: Mar. 29, 2007

(54) Manufacturing method of ceramic body with excellent adiabatic capacity

(76) Inventors: Hong-Jae Lee, Cheonan-si (KR); Gi-Hong Yu, Incheon (KR)

Correspondence Address: PARK LAW FIRM, 3255 WILSHIRE BLVD, SUITE 1110, LOS ANGELES, CA, 90010, US

(21) Appl. No.: 10/574,718

(22) PCT Filed: Jun. 17, 2004
(86) PCT No.: PCT/KR04/01446

§ 371 Date: Apr. 5, 2006

(30) Foreign Application Priority Data
Oct. 7, 2003 (KR) 10-2003-0069407

(51) Int. Cl. C04B 38/00; B29C 44/12; B29C 44/04

(52) U.S. Cl. 501/80; 264/45.3; 264/48

(57) ABSTRACT

The present invention relates to a porous ceramic body with excellent thermal insulation property. The inventive method comprises: an impregnation step in which a polymer sponge having a three-dimensional porous network structure with open cells is immersed in an inorganic adhesive, such that the polymer sponge is completely impregnated with the inorganic adhesive; a dewatering step in which the inorganic adhesive is partially removed from the polymer sponge impregnated with the inorganic adhesive, such that the polymer sponge contains the inorganic adhesive at a amount selected according to the desired density of the porous ceramic body; and a drying step in which the polymer sponge from which the inorganic adhesive had been partially removed in the dewatering step is dried so as to cure the inorganic adhesive.

### TECHNICAL FIELD

The present invention relates to a method for preparing a porous ceramic body with excellent thermal insulation property. More particularly, the present invention relates to a method for preparing a porous ceramic body with excellent thermal insulation property, the method comprising the steps of: immersing a polymer sponge having a three-dimensional porous network structure with open cells in a liquid inorganic adhesive, such that the polymer sponge is completely impregnated with the inorganic adhesive; removing a portion of the inorganic adhesive impregnated into the polymer sponge, such that the polymer sponge contains the inorganic adhesive at an amount selected according to the desired density of the porous ceramic body; and curing the inorganic adhesive.

### BACKGROUND ART

Generally, a porous ceramic body is prepared from ceramic raw material powder. Typical methods for preparing the porous ceramic body include a powder packing technique, a foaming technique and a polymeric sponge technique.

The powder packing technique is a method for forming a porous body by sintering spherical powders at high temperature using gaps as pores, in which the gaps are formed when packing the spherical powders in a bulk state (Journal of Korean Ceramic Society, “Preparation and Properties of Porous Ceramics by Pressureless Powder Packing Method”, 36(6), pp 662-670, 1999).

Thus, the powder packing technique is performed in a relatively simple manner, but has shortcomings in that it is difficult to control pore size and porosity of the resulting porous body, and also the porosity of the resulting porous body is only about half of that of other methods.

Furthermore, as disclosed in Korean Patent Application No. 10-1999-0058380 (entitled “a preparing method of porous ceramics by a foaming technique”) and Korean Patent Application No. 10-2001-0076036 (entitled “preparation technology of porous ceramics by a surfactant”), the foaming method is a method for preparing porous ceramics by various steps including the mixing of ceramic powders as a raw material, slurry preparation, foaming, forming, drying, and sintering.

The foaming step of the preparing method using the foaming technique is performed either by a foaming process using a surfactant or by a foaming process using a foaming material which generates gas by reaction with the raw material mixture. However, both such foaming processes have a shortcoming in that it is difficult to control the porosity and pore size of the resulting ceramic body.

Moreover, as disclosed in U.S. Pat. No. 3,090,094 (entitled “a method of making porous ceramic articles”), Korean Patent Application No. 10-1999-0057840 (entitled “a preparing method of a high-purity ceramic foam with excellent strength”) and Korean Patent Application No. 10-2001-0029138 (entitled “a sound-absorbing material made of hard porous ceramics and a preparing method thereof”), the polymeric sponge technique is a method of preparing a porous ceramic body having the same pore structure as that of a sponge corresponding to a mold, the method comprising various steps, including the mixing of ceramic powders as a raw material, slurry preparation, the impregnation of a sponge with the slurry, the removal of an excess of the slurry, drying, and sintering.

All the three preparing techniques as described above are methods by which a porous ceramic structure is formed by thermally fusing the ceramic powders at high temperature by a sintering process.

Thus, when the thickness of a porous septum is made thin in order to obtain a low-density structure with excellent thermal insulation property, the septum is molten during the sintering process so as to collapse the porous structure, thus making it difficult to obtain a perfect structure.

Also, in preparing a large-sized porous ceramic structure, there is a problem in that microcracking and bending events occur by heat.

In addition, the sintering process generally requires a high temperature of 1,000-2,000° C., although the sintering temperature slightly varies depending on raw materials. In spite of the consumption of many costs, a porous ceramic structure resulted from the sintering process is used in very limited applications, such as catalytic carriers and small-sized filters, since its thermal insulation property and economic efficiency are significantly lower than those of general thermal insulation materials.

In a previous attempt to solve such problems, the present inventors developed a method for preparing a porous ceramic body with excellent thermal insulation property (Korean Patent Application No. 10-2003-0062778 filed on Sep. 8, 2003). This method comprises: impregnating an inorganic adhesive into a polymer sponge having a three-dimensional porous network structure; and dewatering and drying the polymer sponge so as to cure the inorganic adhesive.

However, this method has shortcomings in that the thermal insulation performance of the ceramic body is deteriorated due to water absorption into a coating film formed by the drying of the inorganic adhesive, and a whitening event occurs depending on the kind of the inorganic adhesive used. However, there is no disclosure of solutions to such shortcomings in the above patent application.

### DISCLOSURE OF INVENTION

Technical Problem

In the prior method for preparing a low-density ceramic structure with excellent thermal insulation property, when the thickness of a porous septum is made thin, the septum is molten during the sintering process so as to collapse the porous structure, thus making it difficult to obtain a perfect ceramic structure.

Also, in preparing a large-sized porous ceramic structure, there is a problem in that microcracking and bending events occur by heat.

In addition, the sintering process generally requires a high temperature of 1,000-2,000° C., although the sintering temperature slightly varies depending on raw materials. In spite of the consumption of many costs, a porous ceramic structure resulted from the sintering process is used in very limited applications, such as catalytic carriers and small-sized filters, since its thermal insulation property and economic efficiency are significantly lower than those of general thermal insulation materials.

Technical Solution

The present invention has been made to solve the above-mentioned problems occurring in the prior art, and an object of the present invention is to prepare a porous ceramic body with excellent thermal insulation property at low costs by impregnating a suitable amount of a liquid inorganic adhesive into a polymer sponge having a porous structure, and then curing the inorganic adhesive by a drying process without a sintering process requiring high costs.

Another object of the present invention is to avoid the generation of deterioration in thermal insulation property caused by moisture absorption even when a porous ceramic body is prepared by the steps of impregnating an inorganic adhesive into a polymer sponge, and dewatering and curing the resulting inorganic adhesive.

Still another object of the present invention is to provide a method capable of stably producing a large-sized porous ceramic body in which microcracking and bending events had not occurred.

The present invention relates to a method for preparing a porous ceramic body with excellent thermal insulation property.

In the present invention, the porous ceramic body is prepared by the steps of: immersing a polymer sponge having a three-dimensional porous network structure with open cells in a liquid inorganic adhesive, such that the polymer sponge is completely impregnated with the inorganic adhesive; removing a portion of the inorganic adhesive impregnated into the polymer sponge, such that the polymer sponge contains the inorganic adhesive at an amount selected according to the desired density of the porous ceramic body; and curing the inorganic adhesive.

Accordingly, the inventive method for preparing the porous ceramic body with excellent thermal insulation property includes:

an impregnation step in which a polymer sponge having a three-dimensional porous network structure with open cells is immersed in a liquid inorganic adhesive, such that the polymer sponge is completely impregnated with the inorganic adhesive;

a dewatering step in which the inorganic adhesive is partially removed from the polymer sponge impregnated with the inorganic adhesive, such that the polymer sponge contains the inorganic adhesive at an amount selected according to the desired density of the porous ceramic body; and

drying the polymer sponge so as to cure the inorganic adhesive.

The dewatering step of partially removing, the inorganic adhesive from the polymer sponge is performed by various methods.

More specifically, if the polymer sponge is soft, the inorganic adhesive can be removed by a method using a roller or a method of injecting compressed air onto the polymer sponge.

If the polymer sponge is hard, the inorganic adhesive can be removed by the method of injecting compressed air onto the surface of the polymer sponge, since it is impossible to remove the inorganic adhesive by the roller method.

However, when the formation of continuous open pores where all pores are connected with each other is required to enhance sound-absorbing performance, the inorganic adhesive is removed by injecting compressed air onto the polymer sponge, even if the polymer sponge is soft.

The drying step in the inventive method is preferably carried out at about 100-180° C.

Furthermore, if the polymer sponge is not completely dried until a reduction in the weight of a finished porous ceramic body does not occur, the finished porous ceramic body will show swelling phenomena occurring at a relatively low temperature of about 200° C. For this reason, the polymer sponge is completely dried.

Since the inorganic adhesive remaining in the polymer sponge just after the dewatering step is in a liquid phase, the localization of the inorganic adhesive can occur due to a phenomenon that the inorganic adhesive flows downward.

For this reason, during the drying step just after the dewatering step, it is preferred to frequently reverse the polymer sponge, thus preventing the localization of the inorganic adhesive.

However, if the operations of frequently reversing the polymer sponge are additionally performed in order to prevent the localization of the inorganic adhesive, production costs will be increased and also the localization of the inorganic adhesive cannot be completely prevented so that a slight deterioration in thermal insulation property will not be avoided.

To solve such problems, the inventive method may additionally comprise a curing step for rapidly curing the polymer sponge.

The curing step is performed by a method of introducing a gaseous curing agent, such as carbon dioxide, into the pores of the dewatered polymer sponge.

When carbon dioxide is introduced into the polymer sponge as described above, the carbon dioxide is preferably blown while applying pressure to the polymer sponge in order to achieve raid curing.

Another curing method includes a method of blowing a solid, such as cement, into the pores of the dewatered polymer sponge.

Still another curing method includes a method where the solid curing agent or a liquid curing agent, such as sodium aluminate, is mixed with the inorganic adhesive in the step of providing the raw materials, with the curing agent being added at an amount selected in view of the time taken to reach the dewatering step.

Namely, since the curing rate of the inorganic adhesive is determined depending on the addition amount of the curing agent, the liquid curing agent is added in such an amount that the curing of the inorganic adhesive is so progressed that the localization of the inorganic adhesive does not occur at a time point when the dewatering step is ended.

The curing methods can be selectively applied in view of not only the use of the porous ceramic body but also the convenience of the preparation process.

Moreover, in the present invention, a high-strength porous ceramic body may also be prepared by repeating the steps of impregnating the inorganic adhesive again into the cured ceramic body, and then dewatering and drying the impregnated ceramic-body.

Namely, the impregnating, dewatering and drying steps are performed repeatedly several times, or the impregnating and curing steps are performed repeatedly several times.

Examples of the inorganic adhesive which can be used in the present invention include silicates and modified silicates, such as sodium silicate, potassium silicate and lithium silicate, sol compounds, such as silica sol and alumina sol, and phosphates, such as monoaluminum phosphate (Al₂O₃.3(P₂O₅).6(H₂O)), which are diluted in a suitable amount of water before use in order to facilitate the control of the density of the porous ceramic body.

Furthermore, to further enhance the effect of the present invention, the inorganic adhesive may also be used in a mixture with various additives, such as water repellants, anti-whitening agents, adhesive aids, and heat-resistance improvers.

Concretely speaking, a coating film formed by the drying of the inorganic adhesive has a disadvantage in that its thermal insulation property is reduced by water absorption. To overcome such a disadvantage, the inorganic adhesive may be used in a mixture with a silicon-based or paraffin-based water repellant.

Of the inorganic adhesives, a material such as sodium silicate causes a whitening event that white crystals are formed when sodium ions contained in sodium silicate react with carbon dioxide in the atmosphere. However, if sodium silicofluoride and magnesium sulfate are added to the inorganic adhesive, they will bind with sodium ions causing the whitening event so as to form insoluble salts, thus preventing the whitening event and improving durability.

Moreover, in order that the liquid inorganic adhesive can be uniformly coated on the solid polymer sponge and that the inorganic coating film formed after the drying of the inorganic adhesive can be more strongly attached to the polymer sponge, the inorganic adhesive may be used in a mixture with an adhesive, aid.

Various adhesive aids may be used in the present invention. If a surfactant is used as the adhesive aid, the liquid inorganic adhesive can be more uniformly coated on the solid polymer sponge. If the inorganic adhesive is used with silane coupling agents or organic adhesives, such as polyvinyl alcohol, methyl cellulose, vinyl chloride resin, acrylic resin, and ethylene vinyl acetate (EVA), the organic coating film formed after drying can be more strongly attached to the polymer sponge.

In addition, the inorganic adhesive may also be used in a mixture with heat-resistance improvers, including aluminum hydroxide, magnesium hydroxide, antimony compounds, boric acid, borax, phosphoric acid, phosphate, and phosphorus-based and halogen-based flame retardants, and thermosetting resins, such as melamine, epoxy and phenol.

The heat-resistance improvers as described above render the organic polymer sponge flame-retardant or form many chars in carbonization, thus acting to prevent the shape of the polymer sponge from being changed by heat.

The polymer sponge which is used in the present invention can be soft, semi-hard or hard depending on the use of the resulting porous ceramic body.

Also, the pore size of the polymer sponge can be suitably selected depending on the use of the resulting porous ceramic body. However, a polymer sponge having a slightly larger pore size than the selected size is preferably used in view of the fact that the pore size can be reduced after the polymer sponge is treated according to the inventive method.

Advantageous Effects

According to the present invention, the porous ceramic body can be produced in a simple and low-cost manner. Also, the produced ceramic body has excellent thermal insulation property, so that it can be used as a general thermal insulation material. In addition, the inventive method can stably produce a large-sized porous ceramic body in which microcracking and bending phenomena had not occurred.

### BRIEF DESCRIPTION OF DRAWINGS

FIG. 1 is a flow chart illustrating a method for preparing a porous ceramic body with excellent thermal insulation property according to one embodiment of the present invention.

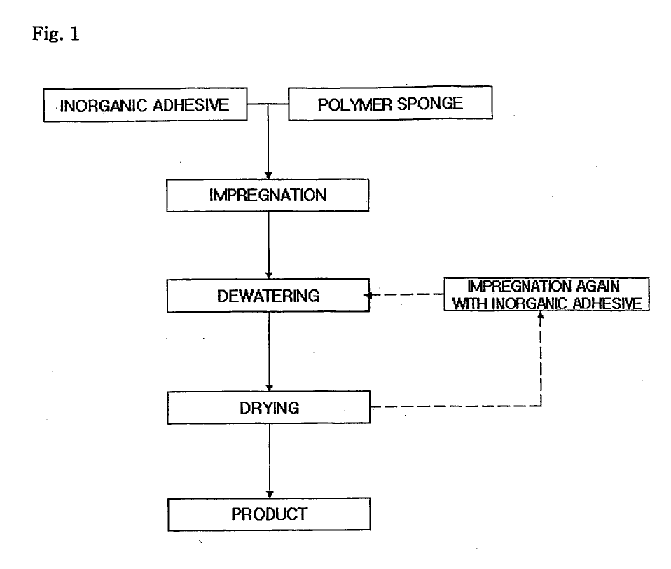

FIG. 2 is a flow chart illustrating a method for preparing a porous ceramic body with excellent thermal insulation property according to another embodiment of the present invention which additionally comprises a curing step.

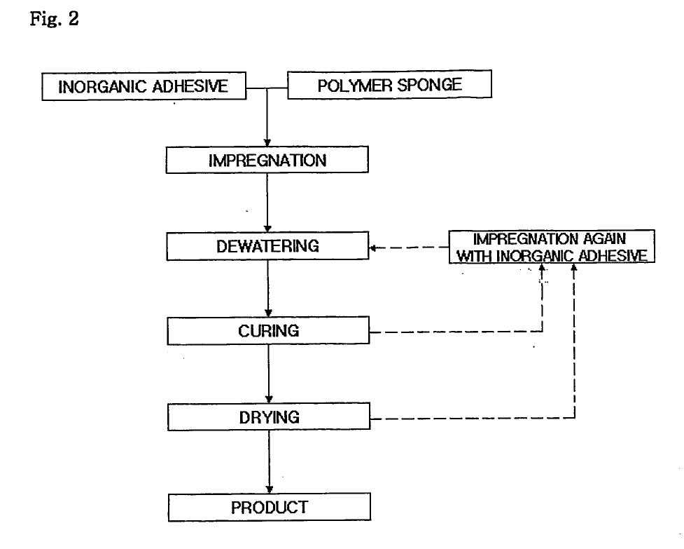

### BEST MODE FOR CARRYING OUT THE INVENTION

Hereinafter, the present invention will be described in detail.

A water bath containing 40° Baume sodium silicate solution, an inorganic adhesive, is provided.

A polyurethane sponge having a size of 300 mm×300 mm×50 mm and a cell size of about 10 pores per linear inch (PPI) is provided.

An impregnation is performed, in which the polyurethane sponge is put in the water bath such that it is immersed in the sodium silicate solution. In this state, the polyurethane sponge is pressed five times such that the polyurethane sponge is completely impregnated with the sodium silicate solution.

After the impregnation step, the polyurethane sponge is taken out from the water bath. Then, a dewatering step is performed, in which an excess of the sodium silicate solution is removed in such a manner that the density of the resulting porous ceramic body becomes a density of about 100 kg/cm³.

After the dewatering step, a curing step is performed, in which carbon dioxide is introduced into the pores of the polyurethane sponge.

After the curing step, the polyurethane sponge is dried in a drying chamber maintained at 105° C. for 24 hours, thus preparing a porous ceramic body.

Mode for Invention

The present invention will hereinafter be described in further detail by examples. It will however be obvious to a person skilled in the art that the technical concept of the present invention is not limited to or by the examples.

### EXAMPLE 1

A water bath containing 40° Baume sodium silicate solution, an inorganic adhesive, was provided.

A polyurethane sponge having a size of 300 mm×300 mm×50 mm and a cell size of about 10 pores per linear inch (PPI) was provided.

An impregnation step was performed, in which the polyurethane sponge was put in the water bath such that it was immersed in the sodium silicate solution. In this state, the polyurethane sponge was pressed five times such that the polyurethane sponge was completely impregnated with the sodium silicate solution.

After the impregnation step, the polyurethane sponge was taken out from the water bath. Then, a dewatering step was performed, in which an excess of the sodium silicate solution was removed such that the density of the resulting porous ceramic body is about 100 kg/cm³.

After the dewatering step, a curing step was performed, in which carbon dioxide was introduced into the pores of the polyurethane sponge.

After the curing step, the polyurethane sponge was dried in a drying chamber maintained at 105° C. for 24 hours, thus preparing a porous ceramic body.

### EXAMPLE 2

A porous ceramic body was prepared in the same manner as in Example 1 except that the dewatering step was performed in such a manner that the density of the resulting porous ceramic body is about 60 kg/cm³.

### EXAMPLE 3

A porous ceramic body was prepared in the same manner as in Example 1 except that the dewatering step was performed in such a manner that the density of the resulting porous ceramic body is about 150 kg/cm³.

### EXAMPLE 4

A porous ceramic body was prepared in the same manner as in Example 1 except that the sodium silicate used as the inorganic adhesive in the impregnation step was replaced by monoaluminum phosphate (Al₂O₃.3(P₂O₅).6(H₂O)) and a drying step was conducted after the dewatering step. The drying step was performed at 140° C. for 24 hours.

### EXAMPLE 5

A porous ceramic body was prepared in the same manner as in Example 4 except that the sodium silicate used as the inorganic adhesive in the impregnation step was replaced by silica sol.

### EXAMPLE 6

A porous ceramic body was prepared in the same manner as in Example 1 except that the sodium silicate used as the inorganic adhesive in the impregnation step was mixed with a silane coupling agent and then impregnated into the polyurethane sponge.

The samples prepared in Examples 1-6 above were measured for their density according to the method of Korean Standard KS F 4714 and for their thermal conductivity according to the method of Korean Standard KS L 9016. The measurement results are summarized in Table 1 below showing comparison with those of a water repellant perlite thermal insulation material (KS F 4714) and a sodium silicate thermal insulation material (KS L 9101), which are commercially available inorganic thermal insulation materials.

TABLE 1
Comparison of thermal conductivities

| | Example | Example | Example | Example | Example | Example | | |
|---|---|---|---|---|---|---|---|---|
| Test item | 1 | 2 | 3 | 4 | 5 | 6 | WRPTIM* | SSTIM** |
| Density | 99 | 70 | 144 | 137 | 106 | 110 | 155 | 170 |
| (kg/cm²) | | | | | | | | |
| Conductivity | 0.0418 | 0.0371 | 0.0454 | 0.0435 | 0.0420 | 0.0421 | 0.047 | 0.047 |
| (kcal/mh° C.) | | | | | | | | |

*WRPTIM: water repellant perlite thermal insulation material
**SSTIM: sodium silicate thermal insulation material

As evident from the above test results, it could be found that the porous ceramic body prepared by the inventive method had excellent thermal insulation properties as compared to those of the prior ceramic body or the commercially available inorganic thermal insulation materials, including the water repellant perlite thermal insulation material (KS F 4714) and the sodium silicate thermal insulation material (KS L 9101).

Also, the porous ceramic body prepared by the present invention was tested for its functional property, and the test results showed that the sound-absorbing property of the inventive porous ceramic body was so excellent that it can be used as a sound-absorbing material.

### INDUSTRIAL APPLICABILITY

As described above, the present invention relates to the method for preparing the porous ceramic body with excellent thermal insulation property.

According to the inventive method, a suitable of the liquid inorganic adhesive is impregnated into the polymer sponge having a porous structure and cured by the drying step, thus preparing the porous ceramic body with excellent thermal insulation property. Accordingly, the inventive method has an advantage in that it can produce the porous ceramic body in a simple and low-cost manner.

Furthermore, the porous ceramic body prepared by the inventive method has excellent thermal insulation and sound-absorbing properties such that it can be used as general thermal insulation and sound-absorbing materials.

In addition, the inventive method can stably produce a large-sized porous ceramic body in which microcracking and bending phenomena had not occurred.

What is claimed is:

1. A method for preparing a porous ceramic body with excellent thermal insulation property, the method comprising:
an impregnation step in which a polymer sponge having a three-dimensional porous network structure with open cells is immersed in an inorganic adhesive, such that the polymer sponge is completely impregnated with the inorganic adhesive;
a dewatering step in which the inorganic adhesive is partially removed from the polymer sponge impregnated with the inorganic adhesive, such that the polymer sponge contains the inorganic adhesive at an amount selected according to the desired density of the porous ceramic body; and
a drying step in which the polymer sponge from which the inorganic adhesive had been partially removed in the dewatering step is dried so as to cure the inorganic adhesive.

2. The method of claim 1, which additionally comprises the step of introducing a gaseous or solid curing agent into the pores of the polymer sponge, before the drying step but after the dewatering step.

3. The method of claim 1, wherein, at the impregnation step, the polymer sponge is immersed in the inorganic adhesive after mixing the inorganic adhesive with a solid or liquid curing agent.

4. The method of any one of claims 1 to 3, wherein the impregnating, dewatering and drying steps are performed repeatedly several times.

5. The method of any one of claims 1 to 3, wherein the inorganic adhesive is at least one selected from the group consisting of silicates and modified silicates, including sodium silicate, potassium silicate and lithium silicate, sol compounds, including silica sol and alumina sol, and phosphate adhesives, including aluminum phosphate and modified aluminum phosphate.

6. The method of any one of claims 1 to 3, wherein, at the impregnation step, the polymer sponge is immersed in the inorganic adhesive after mixing the inorganic adhesive with a surfactant.

7. The method of any one of claims 1 to 3, wherein, at the impregnation step, the polymer sponge is immersed in the inorganic adhesive after mixing the inorganic adhesive with at least one selected from silane coupling agents and organic adhesives.

8. The method of any one of claims 1 to 3, wherein, at the impregnation step, the polymer sponge is immersed in the inorganic adhesive after mixing the inorganic adhesive with at least one selected from sodium silicofluoride and magnesium sulfate.

9. The method of any one of claims 1 to 3, wherein, at the impregnation step, the polymer sponge is immersed in the inorganic adhesive after mixing the inorganic adhesive with a water repellant.

10. The method of any one of claims 1 to 3, wherein, at the impregnation step, the polymer sponge is immersed in the inorganic adhesive after mixing the inorganic adhesive with at least one selected from the group consisting of aluminum hydroxide, magnesium hydroxide, antimony compounds, boric acid, borax, phosphoric acid, phosphate, phosphorus-based and halogen-based flame retardants, and thermosetting resins.

11. The method of claim 2 or 3, wherein the impregnation and curing step are performed repeatedly several times such that the inorganic adhesive is impregnated again into the polymer sponge.

12. A porous ceramic body with excellent thermal insulation property, which is prepared by the method of any one of claims 1 to 3.
